(19) United States
(12) Patent Application Publication
(10) Pub. No.: US 2011/0024367 A1
(43) Pub. Date: Feb. 3, 2011

(54) Cyclic process for in-situ generation of chlorine dioxide in biguanide treated aquatic facilities

(76) Inventor: Roy W. Martin, Downers Grove, IL (US)

Correspondence Address: Roy W. Martin, 1440 Palmer, Downers Grove, IL, 60516, US

(21) Appl. No.: 12/462,068

(22) Filed: Jul. 29, 2009

(51) Int. Cl. C02F 1/72; C02F 1/76

(52) U.S. Cl. 210/759

(57) ABSTRACT

A method for the in-situ generation of chlorine dioxide from dilute solutions of chlorite anions for the enhanced inactivation of microbiological organisms in an aqueous solution of an aquatic facility treated with biguanide.

### FIELD OF INVENTION

This invention relates generally to cleaning an aquatic facility and more particularly to cleaning an aquatic facility that contains organic contaminants that are treated with biguanide sanitizers.

### BACKGROUND

Aquatic facilities that are exposed to various forms of organic contaminants as well as introduction of microbiological contamination must be effectively treated to control transfer of disease.

Aquatic facilities are commonly treated with chlorine or bromine based sanitizers. As an alternative to chlorine, quaternary ammonium compounds, such as the biguanides, and particularly the polyhexamethylene biguanides have become widely used as sanitizers for swimming pool water and other recreational water. Although these organic compounds are good microbiocides, they are not able to oxidize matter as required to provide water clarity. A 27.5% hydrogen peroxide has been used for that purpose because, like chlorine, it has the ability to oxidize organic compounds to forms which are more readily removed from the water. Hydrogen peroxide is also used because it is a powerfill oxidizing agent. It is such a powerful oxidizing agent that this liquid can initiate combustion and cause burns to skin and eyes. However, it is not substantially reactive with the biguanides, which are oxidizable organic compounds.

PMPS reacts with biguanides and therefore its use is limited.

Furthermore, biguanides are not effective against various types of microbiological organisms, more specifically parasitic organism like cryptosporidium.

Chlorine dioxide has been proven very effective at inactivating microbiological organisms. However, generating chlorine dioxide can be hazardous due to the explosive nature of the gas as well as the potential for human exposure to toxic concentrations. Furthermore, chlorite anion concentrations must be held to a minimum in water that may be consumed due to toxicity concerns. The U.S. EPA has put a limit in drinking water at 1.0 ppm as chlorite anion.

Chlorine dioxide is typically produced in a chlorine dioxide generator where either acid or chlorine are combined with a chlorite donor to generate chlorine dioxide. In order to achieve efficient conversion of chlorite to chlorine dioxide, high concentrations are reacted thereby generating a high concentration of gas which is potentially dangerous.

Chlorine dioxide is also produced by forming tablets from reactive components such as dichloroisocynauric acid and sodium chlorite or an acid source and sodium chlorite. These also have limitations and also have the concern of producing chlorine dioxide gas premature to the application due to exposure to relative humidity.

Furthermore, chlorine dioxide also enhances oxidation of organic contaminants but has little effect on the monoamine and diamine structure of biguanide.

### DESCRIPTION OF PRIOR ART

U.S. Patent Application 20080272063 discloses removing organic compounds from soils and groundwater using percarbonate activate persulfate.

U.S. Pat. No. 5,501,802 discloses the use of persulfate to clarify and to reduce the total organic content of swimming pool water treated with biguanide.

U.S. Patent Application 20080272063 does not disclose the treatment of aquatic facilities treated with biguanide. Furthermore, the disclosure does not include the benefits of in-situ generation of chlorine dioxide and the enhanced inactivation in biguanide treated aquatic facilities.

U.S. Pat. No. 5,501,802 discloses the use of persulfate to clarify and to reduce the total organic content of swimming pool water treated with biguanide. However, “802” does not disclose the benefits of combining persulfate and hydrogen peroxide in said systems. Furthermore, “802” does not disclose the invention of a cyclic system for the in-situ generation of chlorine dioxide or its enhanced inactivation in biguanide treated swimming pools.

### SUMMARY

In one aspect, the invention is a composition for reducing chemical oxygen demand in water. The composition includes a persulfate donor, a hydrogen peroxide donor and a chlorite donor. The composition allows in-situ generation of chlorine dioxide without the use of chlorine or bromine which is destructive to biguanide. The composition has particular utility when mammals are present at the time of use.

In yet another aspect, the invention is a method of removing chemical oxygen demand from the aqueous solution of an aquatic facility treated with biguanide.

In yet another aspect, the invention is a method generating chlorine dioxide in-situ or ex-situ for use in aqueous solution of an aquatic facility treated with biguanide.

In yet another aspect, the invention is a method of removing chemical oxygen demand and enhancing inactivation of microbiological organisms in an aqueous solution of an aquatic facility treated with biguanide.

Further still, the invention is a method for the in-situ generation of chlorine dioxide using a cyclic process that converts chlorite to chlorine dioxide at near neutral pH conditions and in dilute concentrations.

### DETAILED DESCRIPTION OF THE EMBODIMENT(S)

As used herein, a “persulfate donor” is any compound or composition that comprises S₂O₈²⁻, such as sodium persulfate, and potassium persulfate. Ammonium persulfate is also an example of a persulfate donor. Typically the concentration persulfate donor ranges from 1 ppm to 10 ppm when mammals are present. In the case of intermittent concentration when mammals are present the persulfate donor concentration can be as high as 20 ppm. For application where a shock treatment is applied such as when mammals do not occupy the aqueous solution of the aquatic facility, the concentration of persulfate donor be as high as 100 ppm.

As used herein, the term “enhanced inactivation” is used with reference to the ability to deactivate, kill, or destroy a microbiological organism at a higher rate than that obtained while sustaining an equivalent concentration of biguanide, or the ability to achieve the same rate or increased rate of inactivation microbiological organisms with lower concentration of biguanide.

As used herein, the term “rate of inactivation” means the time based measurement required to achieve a level of inactivation of an organism. An increased rate of inactivation means the time required to deactivate, kill, or destroy an organism is reduced.

As used herein, the term “increased the rate of inactivation” means the time required to deactivate, or kill the microbiological organisms for a given concentration of free available chlorine or bromine is increased by uses the compositions and/or processes disclosed in the invention.

As used herein, the term “chlorite donor” is a compound that comprises an alkali metal salt comprising chlorite anions ClO₂⁻, chlorine dioxide since it can be reduced to chlorite. Tetrachlorodecaoxide is also to be considered an effective chlorite donor for a similar reason as chlorine dioxide. Preferred chlorite donors include alkali metal salts of chlorite exemplified by sodium chlorite. Any chlorite anions in the aqueous system implementing the disclosed cyclic process of the invention will be regenerated to chlorine dioxide in the disclosed cyclic process.

As used herein, the term “chlorite anion” has the general formula ClO₂⁻.

As used herein, the term “microbiological organisms” is used with reference to all forms of microbiological life forms including: parasites, bacteria, viruses, algae, fungus, and organisms encased in biofilms.

As used herein, the term “an effective amount of hydrogen peroxide donor” is used with reference to achieving a sufficient residual of hydrogen peroxide to induce the decomposition of persulfate anions to produce sulfate free radicals at a desired rate. The molar ratio of hydrogen peroxide as H₂O₂ resulting from the addition of a hydrogen peroxide donor to persulfate as S₂O₈^{═} typically ranges from 1:1 to 50:1. Since the various donors can be applied at different times and feed rates, these ratios do not have to be present all of the time. However the feed rate and ratio of hydrogen peroxide donor should be sufficient and as needed adjusted to limit the persulfate donor concentration to below that which induces irritation to mammals.

As used herein, the term “an effective amount of chlorite donor” is used with reference to achieving a desired residual of chlorine dioxide in the aqueous solution of an aquatic facility while in the presence of a persulfate donor and hydrogen peroxide donor. The persulfate donor and hydrogen peroxide donor do not necessarily have to be in molar excess since additional application of persulfate donor and hydrogen peroxide donor will induce in-situ generation of the chlorite to chlorine dioxide. However in most cases achieving a molar excess of persulfate donor and hydrogen peroxide donor would be desirable.

As used herein, the term “dilute concentration” is used with reference to the chlorite anion concentration in the water. A dilute concentration shall mean no greater than 10 ppm as ClO₂⁻ in the aqueous solution of the aquatic facility.

As used herein, the term “shock” is used with reference to a method of applying a concentration of persulfate donor, hydrogen peroxide donor and chlorite donor that results in a chlorine dioxide concentration higher than 150 ppb as ClO₂.

As used herein, the term “cryptosporidium” is used to represent any form of parasitic microbiological organism from the family of cryptosporidium. An example of cryptosporidium is cryptosporidium parvum (often referred to as C. parvum). Other examples of cryptosporidium include but are not limited to: C. hominis, C. canis, C. felis, C. meleagridis, and C. muris.

The invention discloses a composition and a method for reducing the COD and enhanced inactivation of microbiological organisms from aquatic facilities while the facility is being used by mammals such as swimmers, bathers, etc. Another alternative is to treat the aquatic facility with a “shock” method wherein the concentration of reactants is elevated to generate higher levels of sulfate free radicals and chlorine dioxide that may not be deemed suitable when the aquatic facility is being occupied by mammals. Thus, the accumulation of organic contaminants is significantly reduced and the quality of air and water around the aquatic facilities is enhanced.

The invention allows the application of potentially irritating oxidants (e.g., potassium persulfate) while the water is being used by swimmers/bathers. Irritation to the bathers is avoided by using a hydrogen peroxide donor that reacts with the persulfate to form sulfate free radicals.

The invention entails applying a hydrogen peroxide donor to the water to maintain an “effective amount,” which is sufficient to reduce the persulfate donor concentration by producing sulfate free radicals, and addition of a persulfate donor.

When a low level of persulfate is applied to water in the presence of the hydrogen peroxide donor, sulfate free radicals are formed that effectively decompose the organic compounds, as well as induce formation of other desirable disinfectant such as chlorine dioxide by the activation of chlorite to chlorine dioxide. Furthermore, the generation of sulfate free radicals ensures the chlorite anion concentration does not continue to rise since the chlorite anions are recycled back to chlorine dioxide. Measurement of elevated chlorine dioxide would prompt a reduction in the feed rate of the chlorite donor.

The hydrogen peroxide donor may include but is not limited to: hydrogen peroxide, alkali metal salts of peroxide exemplified by (sodium percarbonate, sodium perborate, calcium peroxide, magnesium peroxide, sodium peroxide and the like).

The composition can be either a powder mixture, granular mixture, or agglomerate containing the persulfate donor, a hydrogen peroxide donor and a chlorite donor such as sodium chlorite The composition of the invention effectively delivers the persulfate donor to the water while maintaining the effective amount of hydrogen peroxide to effectively decompose the persulfate so that the persulfate concentration does accumulate to level that induces irritation when mammals are present. The concentration of persulfate can initially be elevated such as during the periods of a shock treatment wherein the treatment concentration is elevated when no bathers or mammals are present. However, the concentration of persulfate should be sufficiently reduced to prevent irritation prior to allowing mammals into the aqueous solution. This can be assured by providing an effective amount of hydrogen peroxide donor to convert the persulfate to sulfate free radicals.

To form the powder mixture, the hydrogen peroxide donor is admixed with the persulfate donor in a container. In some embodiments, the coating may include a barrier film that isolates the persulfate donor from the surrounding environment (e.g., a chlorite donor). The persulfate donor-hydrogen peroxide donor mixture can be used as is or agglomerated using pressure to form a tablet made of a plurality of granules.

The agglomerates may contain an agent that restricts the dissolution rate of the agglomerate. Examples of such agents include a substantially water insoluble wax such as polyethylene wax, polyoxyethylene wax and their respective fatty acid ester wax. An agent can also be a mineral salt of a carboxylic acid having at least 16 carbons, such as calcium stearate and similar hydrocarbon based salts. Further still, the agent may be a gel-forming material such as a polaxamers, polyacrylic acid, polyacrylamide, polyvinyl alcohol, polysaccharides such as Xanthan, and various cellulose based derivatives. The gel-forming material forms a gelatinous structure upon being exposed to water, effectively controlling the rate at which the agglomerate dissolves in the water.

The composition may be used periodically to prevent the COD level in water from getting too high, it may also be used to recover aquatic facilities that are already highly contaminated with organic based COD.

### EXAMPLE

A 1000 ml beaker was filed to the 1000 ml mark, a 1 inch Teflon coated stirring rod was inserted and the beaker was placed on top of a magnetic stirrer. The mixing speed was set to the lowest possible setting while allowing the stirring rod to rotate. A 1 wt % solution of sodium chlorite was prepared along with 1 wt % sodium persulfate. 170 μl of the stock chlorite solution was added along with 1 ml of stock sodium persulfate and 75 μl of 70% hydrogen peroxide. The timer was started after adding the hydrogen peroxide.

A Palintest 1000 Chlordiox-Duo test kit was used which utilizes the Lissamine Green B method for chlorine dioxide.

At various time increments, 100 ppm of sodium thiosulfate was added to a 15 ml sample and mixed for 15 minutes to remove excess hydrogen peroxide. The sample was then tested for Na₂S₂O₈ using a CHEMetrics Kit K-7870 for sodium persulfate.

| Time (min) | ppm ClO₂ | pH | ppm Na₂S₂O₈ |
|---|---|---|---|
| 10 | 0.27 | 7.41 | 10.0 |
| 20 | 0.26 | 7.42 | |
| 30 | 0.22 | 7.43 | |
| 45 | 0.16 | 7.46 | 4.2 |
| 120 | 0.14 | 7.52 | 2.8 |

The test results show that the reaction between the reagents induced the in-situ formation of chlorine dioxide as well as the reduction in the concentration of sodium persulfate. The results clearly demonstrate the ability to effectively control the concentration of the irritant persulfate while generating chlorine dioxide from dilute concentrations of chlorite.

What is claimed is:

1. A method for reducing chemical oxygen demand and enhanced inactivation of microbiological organisms including cryptosporidium in the aqueous solution of an aquatic facility while mammals are present, the method comprising:
adding a persulfate donor;
adding an effective amount of a hydrogen peroxide donor;
adding an effective amount of a chlorite donor; and
wherein the persulfate concentration remains below 10 ppm measured as Na₂S₂O₈^{═}, the chlorine dioxide concentration is sustained between 40 ppb to 150 ppb, the pH of the said aqueous solution is between 7.0 and 8.0, and a biguanide sanitizer is sustained at a concentration of between 20 and 60 ppm.

2. A method for reducing chemical oxygen demand and increasing the rate of inactivation of microbiological organism including cryptosporidium in an aqueous solution of an aquatic facility treated with a biguanide sanitizer, the method comprising:
adding an effective amount of a persulfate donor to said aqueous solution;
adding an effective amount of hydrogen peroxide donor to said aqueous solution;
adding an effective amount of a chlorite donor to said aqueous solution;
sustaining the pH of said aqueous solution between 6.0 to 8.0; and
wherein the chlorine dioxide concentration is between 150 ppb to 6.0 ppm measured as ClO₂.
